(19) United States
(12) Patent Application Publication
(10) Pub. No.: US 2010/0308547 A1
(43) Pub. Date: Dec. 9, 2010

(54) POWER TOOL

(75) Inventors: Masatoshi Fukinuki, Nanjing (CN); Changxi Dai, Nanjing (CN)

Correspondence Address: GREENBERG TRAURIG, LLP, 77 WEST WACKER DRIVE, SUITE 3100, CHICAGO, IL, 60601-1732, US

(73) Assignee: CHERVON LIMITED, Wanchai (HK)

(21) Appl. No.: 12/789,661

(22) Filed: May 28, 2010

(30) Foreign Application Priority Data
Jun. 5, 2009 (CN) 200920046372.2

(51) Int. Cl. B23B 31/24

(52) U.S. Cl. 279/134

(57) ABSTRACT

A power tool, which includes a handle portion and a housing; a chuck disposed in front of the housing, and the chuck that is selectively operated in one of a working mode and a chucking mode. The power tool further includes a driving device which drives the chuck to axially move between a first position and a second position. The electric tool is in the working mode when the chuck is in the first position and is in the chucking mode when the chuck is in the second position

### RELATED APPLICATION

This application claims the benefit of CN Application No. 200920046372.2, filed on Jun. 5, 2009, which application is incorporated herein by reference in its entirety.

### FIELD OF THE INVENTION

The invention relates to a power tool, and more particularly to a power tool with a quick chuck.

### BACKGROUND OF THE INVENTION

A chuck of the power tool is used for releasably clamping a drill bit. Conventional chucks of power tools need auxiliary tools for tightening or loosening the chuck relative to the drill bit. Recently, the chucks are designed to be capable of being pushed or pressed by hands so as to loosen the chucks relative to the drill bits, and then the user could change the drill bits. However, a user must push and press the chucks with one hand during operation and change the drill bit simultaneously, thus the operation is inconvenient.

### SUMMARY

The object of the present invention is to provide a power tool with a quick chuck, thus the drill bit could be easily changed without pushing and pressing the chuck by hands.

To achieve the object, the power tool according to the present invention comprises a handle portion and a housing; a chuck disposed in front of the housing and capable of being operated in one of a working mode and a chucking mode. The power tool further comprises a driving device which may drive the chuck to axially move between a first position and a second position. The power tool is in the working mode when the chuck is in the first position,and it is in the chucking mode when the chuck is in the second position.

The driving device comprises a driving member, a handling member which may drive the driving member to displace, and an actuating member which makes contact with the chuck and could be driven by the driving member to axially move the chuck between the first position and the second position.

The driving member comprises a first lever which is fixedly connected with the actuating member, and a second lever which is fixedly connected with the handling member at one end and makes contact with a groove formed on the first lever at the other end. The first lever could be driven by the second lever to rotate about a fulcrum.

The driving device further comprises an elastic restoring device which could be a spring.

The power tool of the present invention could achieve the mode changing through moving the handling member with a finger, e.g. the change from the working mode to the chucking mode, thus the user could interchange the drill bit conveniently.

### BRIEF DESCRIPTION OF THE DRAWINGS

FIG. 1 is a schematic view illustrating the structure of the power tool in a working mode of a preferred embodiment according to the present invention; and

FIG. 2 is a schematic view illustrating the structure of the power tool shown in FIG. 1 in a chucking mode.

### DETAILED DESCRIPTION

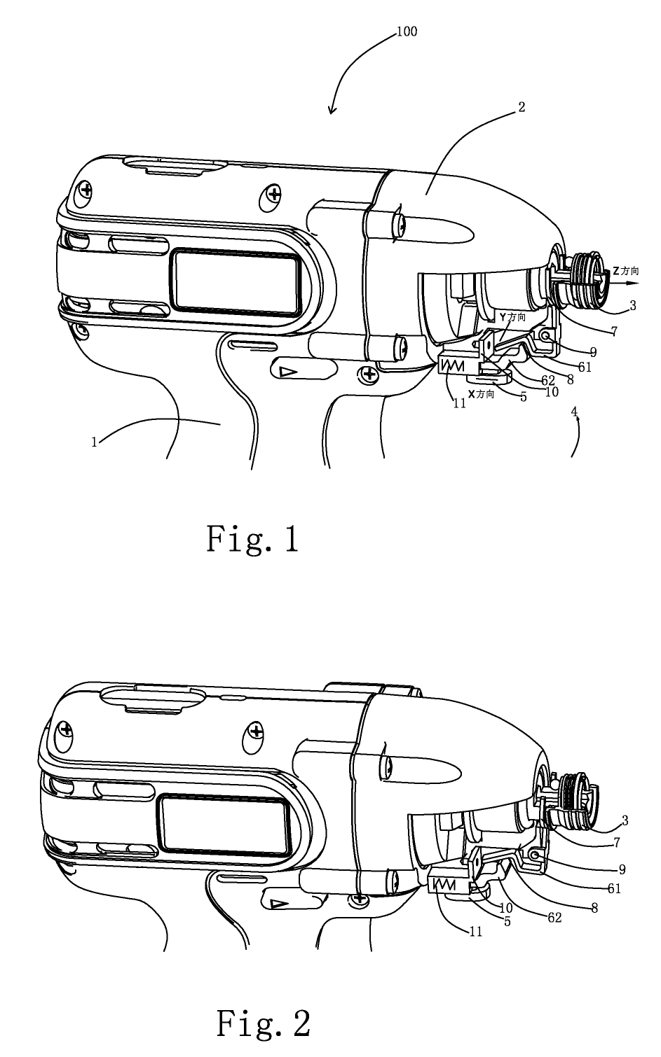

Referring to FIGS. 1 and 2, the power tool according to the present invention is a hand-held power drill 100, which comprises a handle portion 1 and a housing 2. A chuck 3 is arranged in front of the housing and could be selectively operated in one of a working mode and a chucking mode. The power tool 100 further comprises a driving device 4 which could drive the chuck 3 to move between a first position and a second position. The power tool is in the working mode (as shown in FIG. 1) when the chuck is in the first position, and it is in the chucking mode when the chuck is in the second position (as shown in FIG. 2).

The driving device 4 comprises a handling member 5, a driving member and an actuating member 7. The handling member 5 is provided to make the driving member displace, and the actuating member 7 contacts with the chuck 3 and could be driven by the driving member to move the chuck 3 between the first position and the second position. In this embodiment, the driving member includes a first lever 61 and a second lever 62. The first lever 61 is fixedly connected with the actuating member 7, and could rotate about a fulcrum 9. The second lever 62 is fixedly connected with a handling member 5 at one end, and makes contact with the groove 8 formed by the first lever 61 at the other end.

Additionally, a spring 11 is provided for acting on the second lever 62, functioning as a restoring device.

Referring to FIG. 1, when moving the handling member 5 in a direction X by a finger, the second lever 62 moves together with the handling member 5 because one end of the second lever 62 is connected with the handling member 5. The first lever 61 may be driven by the second level 62 to move in a direction Y and rotate about the fulcrum 9 because the other end of the second lever 62 contacts the groove 8 formed by the first lever 61 and slides therein, so the actuating member 7 contacting the chuck makes a displacement. Therefore, the chuck 3 moves from the first position to the second position in a direction Z so as to loosen the chuck, and now the drill bit clamped by the chuck could be changed. The driving member restores under the action of the spring 11 when the finger is loosened from the handling member 5. Because the chuck also has a resetting function, it will return and complete the chucking movement without the action of the force of the actuating member 7.

The above mentioned embodiment is only explanatory to the concept and principle of this invention, without limitation to the contents of the invention. Those skilled in the art will contemplate that this invention will have a lot of other modifications or substitutes which are still within the scope of this invention except for the above preferable embodiment. The protection range of this invention will be determined by the claims hereinafter.

What is claimed is:

1. A power tool, which comprises: a handle portion and a housing; a chuck disposed in front of the housing, wherein the chuck is selectively operated in one of a working mode and a chucking mode and wherein the power tool further comprises a driving device which drives the chuck to move axially between a first position corresponding to the working mode and a second position corresponding to the chucking mode.

2. The power tool of claim 1, wherein the driving device comprises a handling member, a driving member driven by the handling member, and an actuating member which contacts the chuck and driven by the driving member to axially move the chuck between the first position and the second position.

3. The power tool of claim 2, wherein the driving member comprises a first lever which is fixedly connected with the actuating member and a second lever which is fixedly connected with the handling member at one end thereof and contacts a groove formed by the first lever at an opposite end thereof.

4. The power tool of claim 3, wherein the first lever is driven by the second lever to rotate about a fulcrum.

5. The power tool of claim 2, wherein the driving device further comprises an elastic restoring element.

6. The power tool of claim 5, wherein the elastic restoring element is a spring.
